(19) United States
(12) Patent Application Publication
(10) Pub. No.: US 2013/0342072 A1
(43) Pub. Date: Dec. 26, 2013

(54) METHOD FOR ASSEMBLING A COMMUTATOR ONTO THE SHAFT OF A ROTOR AND COMMUTATOR, SHAFT, ROTOR ELECTRIC MACHINE FOR IMPLEMENTING THIS METHOD

(71) Applicants: Gregory Godefroy, Saint Maur Des Fosses (FR); Christophe Dugue, Palaiseau (FR); Khalid Sassane, Champigny Sur Mar (FR)

(72) Inventors: Gregory Godefroy, Saint Maur Des Fosses (FR); Christophe Dugue, Palaiseau (FR); Khalid Sassane, Champigny Sur Mar (FR)

(73) Assignee: VALEO EQUIPEMENTS ELECTRIQUES MOTEUR, Creteil (FR)

(21) Appl. No.: 13/884,768

(22) PCT Filed: Nov. 10, 2011
(86) PCT No.: PCT/FR2011/052617

§ 371 Date: Sep. 4, 2013

(30) Foreign Application Priority Data
Nov. 18, 2010 (FR) 1059460

(51) Int. Cl. H01R 39/14; H01R 43/08

(52) U.S. Cl. CPC H01R 39/14; H01R 43/08
USPC 310/235; 29/597

(57) ABSTRACT

A method of force-fitting a commutator (3) onto the shaft (2) of a rotor. This force-fitting is over an externally knurled part (6) of one end (4) of the shaft. The force-fitting is performed in such a way that the externally knurled part remains located on the outside of a first portion (A) of the commutator supporting the slip rings (8). According to another feature, an internally knurled part (9) of the commutator, situated essentially on the outside of the first portion (A), is force-fitted over an externally plain part (7) of the end of the shaft. The method has the notable advantage of allowing longer brush life. The method is particularly well suited to applications to a motor vehicle alternator or alternator-starter.

### TECHNICAL FIELD OF THE INVENTION

The present invention relates to a process for assembly of a commutator on the shaft of a rotor of a rotary electrical machine, as well as the adapted shaft and commutator.

The invention also relates to a rotor comprising a shaft and a commutator of this type, as well as a rotary electrical machine equipped with a rotor of this type.

### TECHNOLOGICAL BACKGROUND OF THE INVENTION

A commutator comprising collector rings which permit the supply of current to the winding(s) of a rotor of a rotary electrical machine is generally produced in the form of a separate part which is then added onto one end of the rotor shaft.

It is known to produce a commutator of this type by over-moulding of insulating material onto electrically conductive elements, such as to form a body with a globally cylindrical form which has conductive rings on its outer surface, and in its interior has elements for connection of the rings to the ends of the winding(s). An axial bore allows the commutator to be placed at the end of the rotor shaft.

The assembly of the commutator on the shaft is a delicate operation, since it must comply with diverging objectives:
the commutator must be secured integrally on the shaft;
the mechanical stresses applied to the commutator during the assembly must be low, since the material of the commutator, which in particular is plastic, generally breaks very easily;
the process must be simple to implement for mass production.

The process described in American patent U.S. Pat. No. 4,114,056 consists of forcing the commutator by means of a press onto the shaft, the end of which has been knurled.

This process is simple, but during the assembly operation, the outer knurled part of the shaft, comprising teeth with sharp ridges in the case of substantial knurling, causes cracks in the commutator.

Experience has shown that these cracks make the commutator mechanically fragile and are the cause of short-circuits between the shaft and the collector rings.

In addition, the deformation of the commutator after it has been forced onto the shaft, and in particular of the collector rings, is not regular. A circular section becomes elliptical. This fault results in premature wear of the brushes, and leads to reduction of the service life of the machine.

A reduction of the height of the teeth of the knurling would make it possible to eliminate the aforementioned disadvantages, but would reduce the reliability of the securing of the commutator on the shaft.

A process such as that described in patent application FR2514209 would probably make it possible to improve the attachment between the commutator and the outer knurled part of the shaft, by interposition of an impregnation resin.

However, a process of this type would detract from the ease of implementation.

### GENERAL DESCRIPTION OF THE INVENTION

The object of the present invention is thus to eliminate the above-described disadvantages by proposing a process for assembly of a commutator on the shaft of a rotor, by forcing the commutator onto an outer knurled part of an end of the shaft, which is distinguished in that this forcing is carried out such that the outer knurled part remains situated on the exterior of a first portion of the commutator which supports collector rings.

In addition, according to this process an inner knurled part of the commutator which is situated substantially on the exterior of this first portion is advantageously forced onto an outer smooth part of the end of the shaft.

A commutator which is adapted for implementation of the process according to the invention, and is of the type produced by over-moulding of insulating material onto electrically conductive elements comprising collector rings, is distinguished in that it comprises an inner knurled part which is situated substantially on the exterior of a first portion of the commutator which supports the collector rings.

Preferably, this commutator has an inner smooth part on the exterior of its inner knurled part.

A rotor shaft which is adapted for the implementation of the process according to the invention is also distinguished in that it comprises an end with an outer knurled part which can co-operate with a second portion of a commutator which does not support collector rings of this commutator.

The end of this shaft preferably has an outer smooth part on the exterior of the outer knurled part.

The invention also relates to a rotor comprising a commutator and a shaft as previously described, as well as a rotary electrical machine comprising a rotor of this type.

These few essential specifications will have made apparent to persons skilled in the art the advantages provided by the process for assembly of a commutator on the shaft of a rotor according to the invention, in comparison with the prior art, at the level of retention of the commutator on the shaft without deterioration of the collector rings.

When this rotary electrical machine is an alternator or alternator-starter of a motor vehicle, the extended service life of the brushes made possible by the present invention is a very significant advantage.

The detailed specifications of the invention are given in the description which is provided hereinafter in association with the appended drawings. It should be noted that these drawings serve the purpose only of illustrating the text of the description, and do not constitute in any way a limitation of the scope of the invention.

### BRIEF DESCRIPTION OF THE DRAWINGS

FIG. 1 illustrates the process of assembly on the shaft of a rotor according to the invention.

FIG. 2a is an end view of the end of a shaft of a rotor according to the invention.

FIG. 2b is an end view of a commutator according to the invention.

FIG. 3 is a view in axial cross-section of the commutator and the end of the shaft of the rotor according to the invention.

### DESCRIPTION OF THE PREFERRED EMBODIMENT OF THE INVENTION

The optimisation of the assembly 1 and of the clamping between the shaft 2 and the commutator 3 consists of modifying the two surfaces in contact, in order to reduce the deformations of the rings, without detracting from the level of clamping.

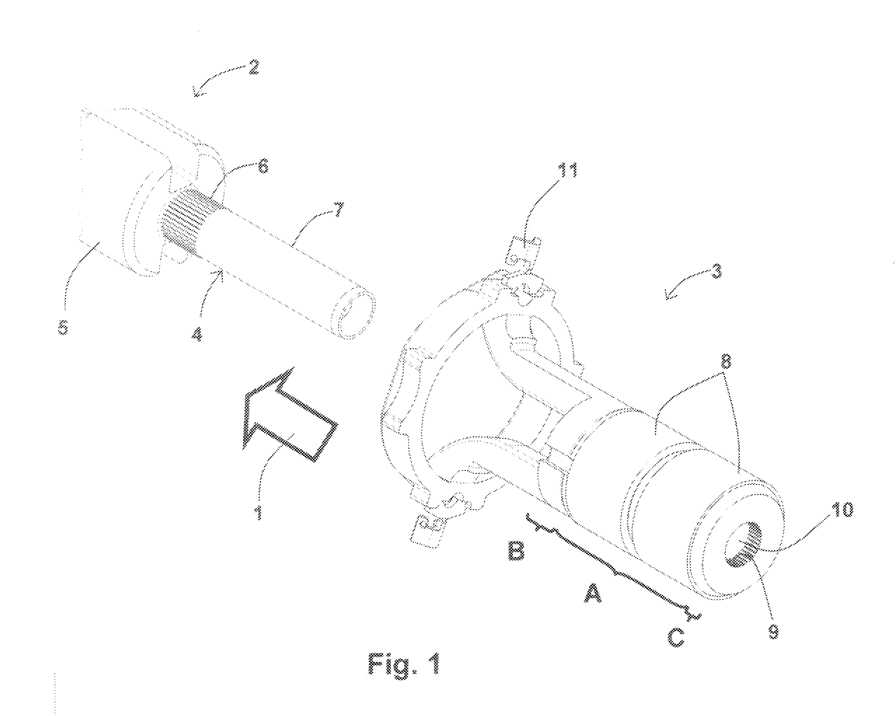

FIG. 1 shows clearly the solution proposed, consisting of assembling a shaft 2 and a commutator 3 which are partially knurled.

On the side 5 of the connections of the winding for excitation of the rotor, the end 4 of the shaft 2 has an outer knurled part 6.

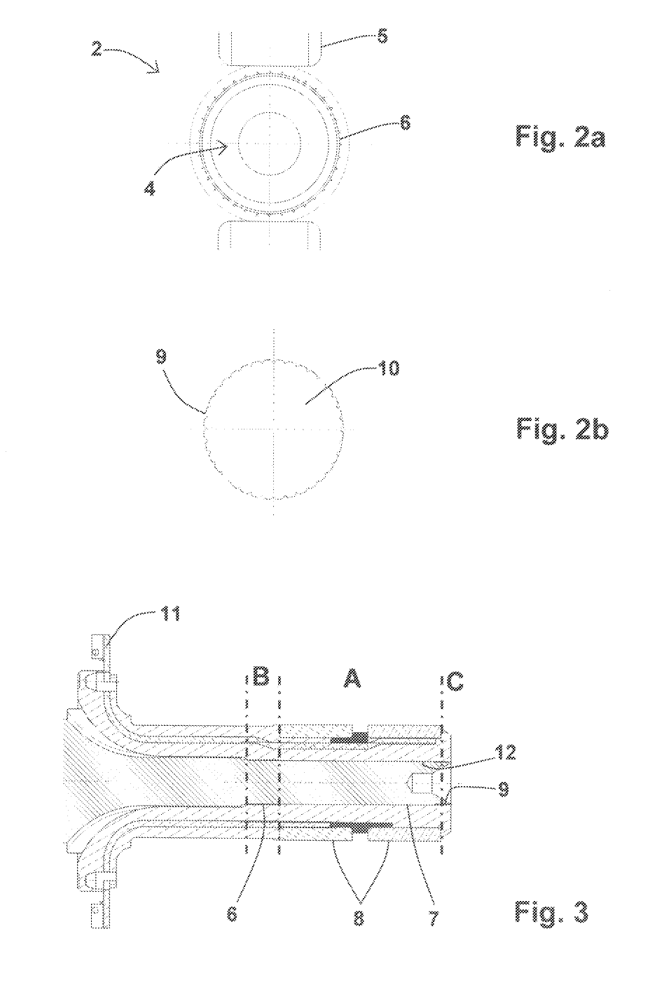

The end view of the end 4 of the shaft 2 in FIG. 2a shows clearly the profile in the form of teeth of the axial ridges which constitute the knurling 6.

In this embodiment, there are 36 of these teeth, which are distributed regularly on the periphery of the end 4 of the shaft 2 with an outer diameter of approximately 5.6 mm, and the teeth have a height of approximately 0.1 mm.

The outer knurled part 6 extends axially only around approximately 5 mm in this particular embodiment of the invention.

The largest part of the end 4 of the shaft 2 is therefore smooth.

This outer smooth part 7 does not deform the commutator 3 during the assembly 1, and in particular the collector rings 8, in that, in the process according to the invention, the outer knurled part 6 remains situated on the exterior of a first portion A of the commutator 3 which supports these rings 8.

The retention of the commutator 3 on the end of the shaft 2 is assured by the deformation of the material of the commutator 3, such as plastic, which is less hard than the material of the shaft 2, which is generally made of steel, at the level of a second portion B of the commutator 3 which does not support the collector rings 8.

In order to avoid any play, additional retention of the commutator 3 on the end 4 of the shaft 2 is obtained by providing the commutator 3 with an inner knurled part 9 which is situated substantially on the exterior of the first portion A of the commutator 3 and at the level of a third end portion C.

In these conditions, the deformation of the material of the commutator 3, which permits the clamping of the commutator 3 on the end 4 of the shaft 2 of the rotor, does not affect the form of the collector rings 8, which remain cylindrical.

The end view of the commutator 3 in FIG. 2a shows clearly the profile in the form of teeth of the axial grooves which constitute the knurling 9.

In this embodiment, there are 36 of these teeth, which are distributed regularly on the periphery of the axial bore 10 with an inner diameter of approximately 5.6 mm, and the teeth have a depth of approximately 0.1 mm.

The inner knurled part 9 extends axially only around approximately 2 mm in this particular embodiment of the invention.

The largest part of the axial bore, 10, towards the electrically conductive elements 11, is therefore smooth.

As shown clearly by the axial cross-section in FIG. 3, the inner smooth part 12 of the commutator 3 and the outer smooth part 7 of the end 4 of the shaft 2 are opposite the level of the first portion A of the commutator which supports the collector rings 8, when the commutator 3 and the shaft 2 are assembled.

The inner diameter of the axial bore in the commutator 3 is advantageously substantially identical to the outer diameter of the end 4 of the shaft 2 of the rotor, i.e. approximately 5.6 mm in this embodiment. Thus, guiding is obtained without any effect on the form of the collector rings 8.

The advantage of the process for assembly of a commutator 3 on a shaft 2 according to the invention, and of the adapted commutator 3 and shaft 2, is that, because of the partial knurling on the shaft 2 and on an end C of the commutator 3, good retention of the commutator 3 is assured without significant deformation of the collector rings 8.

Since the collector rings 8 are less deformed during the assembly operation, a rotary electrical machine provided with a rotor comprising a commutator 3 and a shaft 2 assembled by means of the process according to the invention will have its service life extended, since the forces and vibrations caused by ovalisation of the collector rings 8 will be lower, and consequently the wear of the brushes will be decreased.

It will be appreciated that the invention is not limited simply to the above-described preferred embodiment.

The number of collector rings shown, the number of teeth of the knurled parts indicated, and the dimensions specified, are only examples.

Persons skilled in the art will easily apply the above-described process for assembly of a commutator 3 on the shaft 2 of a rotor described above to rotary electrical machines of all sizes.

The invention thus incorporates all the possible variants within the limit of the subject of the following claims.

1. Process for assembly of a commutator (3) on the shaft (2) of a rotor, by forcing the commutator onto an outer knurled part (6) of an end (4) of said shaft (2), wherein this forcing is carried out such that said outer knurled part (6) remains situated on the exterior of a first portion (A) of said commutator (3) which supports collector rings (8).

2. Process for assembly of a commutator (3) on the shaft (2) of a rotor according to the preceding claim 1, characterized in that an inner knurled part (9) of the said commutator (3) which is situated substantially on the exterior of said first portion (A) is forced onto an outer smooth part (7) of said end (4) of said shaft (2).

3. Commutator (3) which is adapted for implementation of the process according to claim 1, and is of the type produced by over-moulding of insulating material onto electrically conductive elements (11) comprising collector rings (8), said commutator (3) comprises an inner knurled part (9) which is situated substantially on the exterior of a first portion (A) of said commutator (3) which supports said collector rings (8).

4. Commutator (3) according to claim 3, characterized in that said commutator (3) has an inner smooth part (12) on the exterior of said inner knurled part (9).

5. Commutator (3) according to claim 4, characterized in that said commutator (3) has an inner diameter of approximately 5.6 mm, and in that said inner knurled part (9) has 36 teeth with a depth of approximately 0.1 mm which extend axially around approximately 2 mm.

6. Shaft (2) for a rotor adapted for implementation of the method according to claim 1, characterized in that said commutator (3) comprises an end (4) with an outer knurled part (6) which can co-operate with a second portion (B) of a commutator (3) which does not support collector rings (8) of said commutator (3).

7. Shaft (2) for a rotor according to the preceding claim 6, characterized in that said end (4) has an outer smooth part (7) on the exterior of said outer knurled part (6).

8. Shaft (2) for a rotor according to the preceding claim 7, characterized in that said end (4) has an inner diameter of approximately 5.6 mm, and in that said outer knurled part (6) has 36 teeth with a height of approximately 0.1 mm which extend axially around approximately 5 mm.

9. Rotor comprising a commutator (3) according to claim 3, and a shaft (2) according to claim 6.

10. Rotary electrical machine, comprising a rotor according to the preceding claim 9.
